(19) United States
(12) Patent Application Publication
(10) Pub. No.: US 2013/0067819 A1
(43) Pub. Date: Mar. 21, 2013

(54) Magnetic cover

(71) Applicant: Mark McLain, Carbondale, CO (US)

(72) Inventor: Mark McLain, Carbondale, CO (US)

(21) Appl. No.: 13/200,188

(22) Filed: Sep. 20, 2011

(51) Int. Cl. E06B 5/00; E06B 7/16

(52) U.S. Cl. 49/463

(57) ABSTRACT

A removable cover for an opening in a structure comprising a rigid sheet attached to the opening on the surface of the structure to be covered by means of magnets and a ferrous frame attached to either the surface to be covered or the cover itself and capable of providing both insulation and sealing of the opening when such magnets are in contact with the frame.

### FIELD OF THE INVENTION

The present invention relates to a cover adapted for placing over an opening in a building or similar structure, such as in particular an attic opening, which is readily removable and yet provides both insulating and sealing capabilities. More particularly the cover of the present invention employs magnetic forces to not only keep the cover in place over the opening, but also to seal the opening against air passage. The cover of the present invention can be readily adapted to any opening design and is adjustable in its attachment and removal strength.

### THE PRIOR ART

The prior art has concerned itself principally with removable covers for building openings that are attic hatches or openings. The purpose of such openings is to provide access to the attic or may be used for the placement of a fan or other device in the ceiling of a room. The devices of the prior art either are not readily removable or if removable provide inadequate sealing ability to prevent either undesirable air from penetrating into a building or desirable air from escaping from the building. Furthermore those that are capable of providing both insulating and air tight seals are expensive, difficult to install, or difficult to remove and place back over the opening. Frequently when used the covers interfere with the existing insulation above the opening or require the placement of separate insulating material.

### SUMMARY OF THE INVENTION

The cover of the present invention is adapted to provide both sealing and insulating properties. It can be used for any type of opening and can be adjusted as to the force applied to adhere or remove the cover from the opening.

More specifically the cover of the present invention in a preferred embodiment comprises (1) a ferrous metal frame, capable of attracting a magnet, surrounding the an opening in the surface of a structure to which the frame is attached in a permanent manner (2) a solid, rigid cover extending on all sides beyond the opening and the attached metal frame, (3) flexible sealing material, generally in the form of a gasket, permanently attached to the interior surface of the cover in a position to removably contact the surface of the structure to which the metallic frame is attached and (4) magnets permanently attached to the interior surface of such cover, in a position to engage the metallic frame with sufficient spacing to allow the flexible sealing material attached to the cover to removably come into contact with the surface having the frame attached thereto when the magnets are in contact with the frame. In order to provide an airtight seal it is also preferred to employ a sealing material between the frame and the surface to which it is attached. The magnets and the flexible sealing material are positioned such that the magnets exert sufficient pressure on such sealing material to provide an airtight seal against the surface of the structure. The cover itself can be any rigid solid material but is generally solid wood, ply wood, wood composite but is not limited to such materials.

In a preferred embodiment, particularly where the cover is used as an attic hatch, the inside of the cover containing the magnets and sealing gasket also contains a rigid insulating block fitting within the opening to be covered to provide an improved thermal barrier when the cover is attached to the opening. The magnets used are preferably well-known commercially available rare earth magnets because of their greater strength, although standard ferrite magnets, if used in sufficient number to provide the required attraction to the frame, may also be used. Preferably the sealing gasket on the cover is a continuous strip, in the form of a flexible material, around the circumference of the opening and placed between the actual opening and the magnets attached to the cover. Although in a preferred embodiment the magnets are attached to the cover and the frame to the finished or interior building side it is equally possible to reverse the placement of the frame on the cover and magnets and sealing gasket on the surface such that the magnets and sealing gasket are permanently attached to the building surface at the opening and the cover has the continuous metal frame attached on its interior side. The cover of the present invention is not limited for use inside a building or structure but it can similarly used on openings in the exterior surfaces of structures such as a cover for windows and doors. The number and type of magnets to be used can be adjusted to provide the degree of contact of the cover with the surface containing the opening However the number should be adequate to keep the cover in place when placed against the opening.

### BRIEF DESCRIPTION OF THE DRAWINGS

FIG. 1 is a perspective view of a ceiling opening and a rigid ferrous frame having a flexible gasket attached to the side facing the ceiling to be placed against the inner surface of the ceiling.

FIG. 2 is a perspective view of a ferrous frame surrounding the opening showing the sealing foam gasket and the openings in the frame for nails or screws to secure the frame to the ceiling.

FIG. 3 is a perspective view of the inner side of the cover showing the insulating block, the magnets to hold the cover to the ferrous frame and a flexible gasket to create an air seal between the opening and the building interior.

FIG. 4 is a plan view of the side of the cover facing the opening the magnets, and the flexible gasket on the cover.

FIG. 5 is a partial perspective view of the surface of the cover facing the opening.

FIG. 6 is a partial cross sectional view of cover showing the attachment of the cover to a ceiling.

### DETAILED DESCRIPTION OF PREFERRED EMBODIMENT

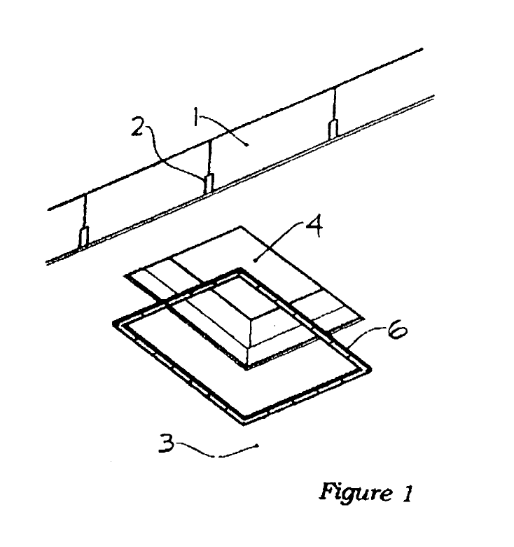

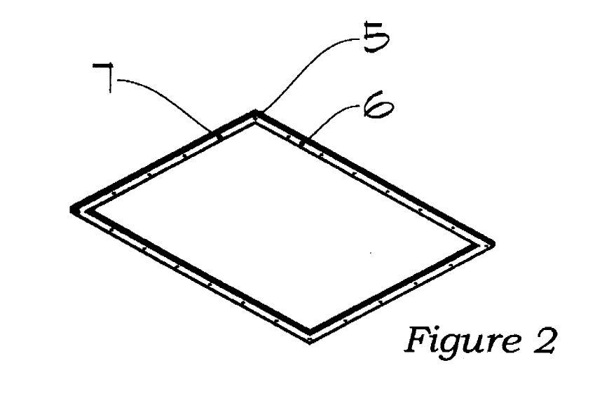

FIG. 1 shows the ferrous frame 6 surrounding the opening 4 in a building ceiling between the trusses or joists generally found in a ceiling 3 with insulation 1 normally installed above the above the ceiling. The frame is preferably rigid in form for ease of installation to surround the opening and metallic in nature to provide greatest adhesive strength to the magnets in the cover. As shown in FIG. 2 the ferrous frame 6 contains sealing material in the form of a flexible gasket 5 on the side facing the building surface such as a ceiling, which not only protects the ceiling but also provides an air tight seal between the frame and the building surface. The frame is normally attached to the surface of a structure by means of nails, screws or bolts through holes 7 in the frame. It is equally possible, however to employ an adhesive which not only provides a seal between the frame and the surface but also attaches the frame in a permanent manner to the surface,

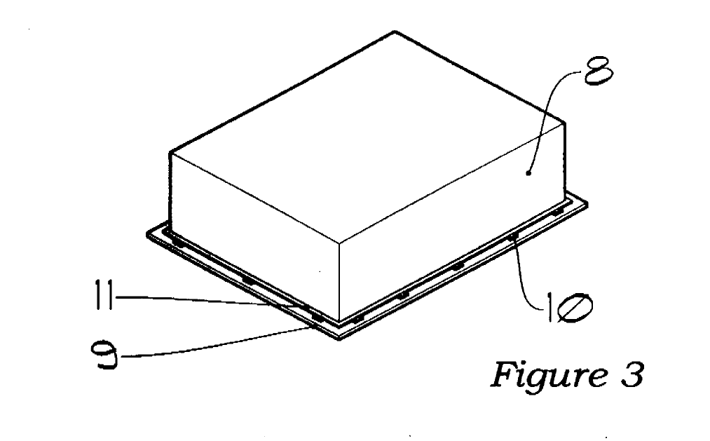

FIG. 3 is a perspective view of the side of the cover 9 facing the opening and an insulating block 8 creating a ledge extending beyond the opening and overlapping the ferrous frame 6, to which a flexible sealing gasket 11 and a set of magnets 10 is attached. In the event that the block is intended to supply additional insulation, it is of such size as to cover the entire surface of the cover exposed to the opening to provide maximum insulation. The block is not an essential part of the cover of the present invention and can be replaced with other items such as a flashlight and flashlight holder. The cover contains a ledge which extends the cover beyond the opening. Any flexible gasketing material is suitable a long as it is flexible enough and applied in sufficient height to provide an air tight seal between the cover and the inner surface of the structure to which the cover is to be attached when the magnets are in contact with the frame. The magnets can be attached by any conventional means to the cover such as a holder for the magnets or by means of screws through the magnet or a strong adhesive. In order to achieve an air tight seal the flexible sealing gasket extends beyond the height of the magnets so that it becomes compressed when the magnets are in contact with the frame. The magnets are preferably rare earth magnets with stronger adhering powers as compared to standard magnets. The size and number of magnets to be employed depends on the weight of the cover and the holding power desired for any particular application.

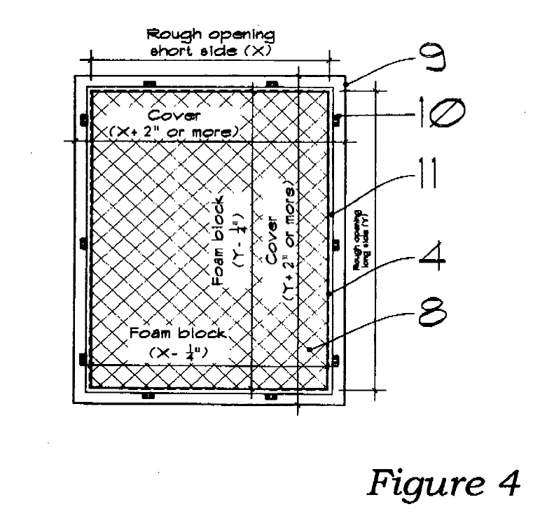

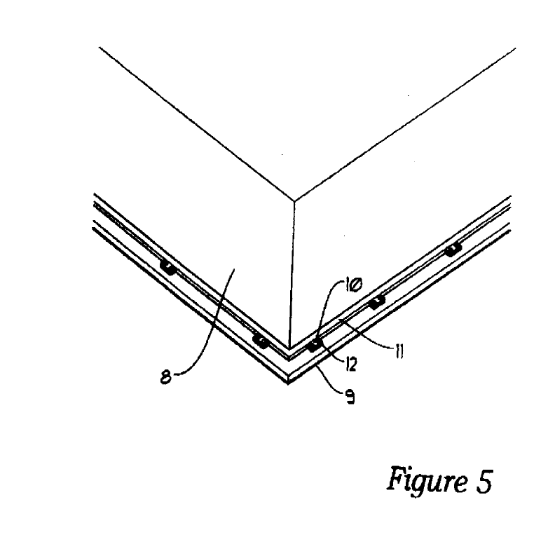

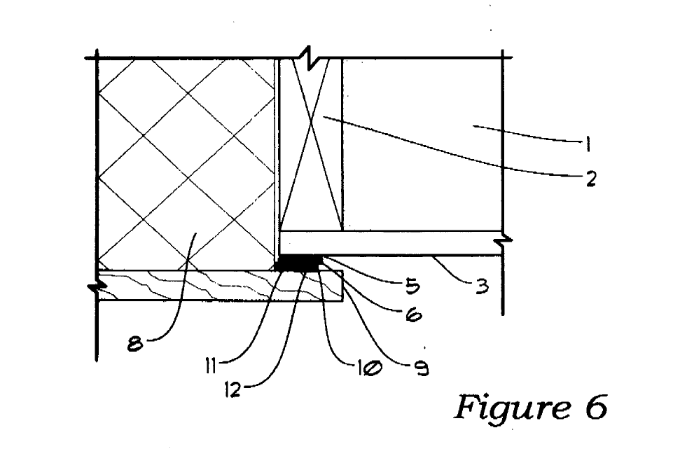

FIG. 4 shows a planar view of the cover 9 facing the opening attached to which is the insulating block 8 protruding into the opening, the flexible sealing gasket 11 surrounding the insulating block and the magnets 10 in a position on the cover 9 so as to contact and attach themselves to the frame on the interior side of a building. The drawing shows 10 magnets 10 surrounding the ledge of the cover 9 extending beyond the opening in a position to contact the frame on the interior side of the building. The number and strength of the magnet can be varied to adjust to the force with which the cover is to be held against the frame and the strength desired to release the magnets and remove the cover. FIG. 5 shows a partial perspective view of the cover at one of its corners in which 9 refers to the rigid cover, 8 to the insulating block, 10 to the magnets and 11 to the flexible sealing gasket. The magnets are placed on top of an iron backer 12 to increase the strength of the magnets. FIG. 6 is a cross sectional view of part of one embodiment of the invention showing the attachment of the cover 9 through magnets 10 attached to the interior surface of a ceiling 3 which in turn is attached to the joists 2 having insulation 1 placed between the joists The frame 6 is attached to the ceiling with sealing material 5 providing an air tight seal and is in contact with the magnet 10 and metal backing 12. The magnet causes the sealing foam gasket 11 on the cover 9 to seal against the ceiling by contact with the ferrous metal frame 6.

If access to the opening is desired a user simply grabs the edges of the cover, and applies outward pressure on the cover until it exceeds the attaching force of the magnets thereby releasing the cover. If desired it is possible to attach handles or other means of removing the cover from the to the opening. The foregoing description will make it obvious that the magnetic cover of the present invention can find many applications in the construction of buildings as well as other structures such as boats, house trailers, trains and airplanes.

1-9. (canceled)

9. Removable cover for positioning over a ceiling opening in a building, comprising,
a. a ferrous metallic frame surrounding the opening and attached to the inner ceiling surface to be covered,
b. a cover comprising a rigid sheet covering the opening and extending beyond the opening on all sides of the opening,
c. magnets attached to the side of the cover facing the opening on the part extending beyond the opening in a position to contact the ferrous frame and in sufficient number to hold the cover against the surface of the ceiling,
d. a flexible sealing gasket attached to the side of the cover facing the opening on the part extending beyond the opening such that a seal is formed when the magnets on the cover are in contact with the ferrous metallic frame, and
e. a rigid insulating block attached to the surface of the cover facing the opening and extending into the opening thereby providing an improved thermal barrier.

10. The removable cover of claim 9 wherein the ferrous frame contains a sealing malarial, on the surface of the frame in contact with the surface to be covered such as to form a seal between the frame end the surface of the structure.

11. The removable cover of claim 10 wherein the sealing material bonds the frame to the surface.

12. The cover of claim 9 wherein the flexible sealing gasket extends above the surface of the magnets and is compressed by the magnets when such are in contact with the frame.

13. Removable cover for positioning over a ceiling opening in a building comprising,
a a cover comprising a rigid sheet covering the opening and extending beyond the opening on all sides of the opening,
b a metallic frame attached to the side of the cover facing the opening on the part extending beyond the opening,
c. magnets attached to the surface of the ceiling opening at positions to be able to contact the ferrous frame and in sufficient number to hold the cover against the surface of the structure,
d. a flexible sealing gasket attached to the side of the cover facing the opening on the part extending beyond the opening such that a seal is formed when the magnets on the magnets are in contact with the ferrous metallic frame, and
e. a rigid insulating block attached to the surface of the cover facing the opening and extending into the opening thereby providing an improved thermal barrier.
